(19) United States
(12) Patent Application Publication
(10) Pub. No.: US 2023/0106447 A1
(43) Pub. Date: Apr. 6, 2023

(54) CYCLIC SHIFTS FOR MULTIPLE RESOURCE BLOCK PHYSICAL UPLINK CONTROL CHANNEL COMMUNICATIONS

(71) Applicant: QUALCOMM Incorporated, San Diego, CA (US)

(72) Inventors: Qingjiang TIAN, San Diego, CA (US); Jing SUN, San Diego, CA (US); Xiaoxia ZHANG, San Diego, CA (US); Tao LUO, San Diego, CA (US)

(21) Appl. No.: 17/930,684

(22) Filed: Sep. 8, 2022

Related U.S. Application Data
(60) Provisional application No. 63/262,002, filed on Oct. 1, 2021.

(51) Int. Cl. H04W 72/12; H04L 27/26; H04L 5/00

(52) U.S. Cl. CPC H04W 72/1268; H04L 27/2605; H04L 5/0053

(57) ABSTRACT

Various aspects of the present disclosure generally relate to wireless communication. In some aspects, a user equipment (UE) may process, for a physical uplink control channel (PUCCH) communication, information to be included in the PUCCH communication based at least in part on applying a cyclic shift, from a set of cyclic shifts, to the information, wherein the PUCCH communication is associated with multiple resource blocks (RBs), wherein a quantity of the multiple RBs is M, and wherein the set of cyclic shifts include cyclic shift values of 0, M, 3M, 4M, 6M, 7M, 9M, and 10M. The UE may transmit, based at least in part on processing the information, the PUCCH communication including the information. Numerous other aspects are described.

### CROSS-REFERENCE TO RELATED APPLICATION

This patent application claims priority to U.S. Provisional Patent Application No. 63/262,002, filed on Oct. 1, 2021, entitled “CYCLIC SHIFTS FOR MULTIPLE RESOURCE BLOCK PHYSICAL UPLINK CONTROL CHANNEL COMMUNICATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for cyclic shifts for multiple resource block (RB) physical uplink control channel (PUCCH) communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to process, for a physical uplink control channel (PUCCH) communication, information to be included in the PUCCH communication based at least in part on applying a cyclic shift, from a set of cyclic shifts, to the information, wherein the PUCCH communication is associated with multiple resource blocks (RBs), wherein a quantity of the multiple RBs is M, and wherein the set of cyclic shifts include cyclic shift values of 0, M, 3M, 4M, 6M, 7M, 9M, and 10M. The one or more processors may be configured to transmit, based at least in part on processing the information, the PUCCH communication including the information.

Some aspects described herein relate to a base station for wireless communication. The base station may include a memory and one or more processors coupled to the memory. The one or more processors may be configured to receive, from a UE, a PUCCH communication that includes information, wherein the PUCCH communication is associated with multiple RBs. The one or more processors may be configured to decode the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M.

Some aspects described herein relate to a method of wireless communication performed by a UE. The method may include processing, for a PUCCH communication, information to be included in the PUCCH communication based at least in part on applying a cyclic shift, from a set of cyclic shifts, to the information, wherein the PUCCH communication is associated with multiple RBs, wherein a quantity of the multiple RBs is M, and wherein the set of cyclic shifts include cyclic shift values of 0, M, 3M, 4M, 6M, 7M, 9M, and 10M. The method may include transmitting, based at least in part on processing the information, the PUCCH communication including the information.

Some aspects described herein relate to a method of wireless communication performed by a base station. The method may include receiving, from a UE, a PUCCH communication that includes information, wherein the PUCCH communication is associated with multiple RBs. The method may include decoding the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M 9M, and 10M.

Some aspects described herein relate to a non-transitory computer-readable medium that stores a set of instructions for wireless communication by a UE. The set of instructions, when executed by one or more processors of the UE, may cause the UE to process, for a PUCCH communication, information to be included in the PUCCH communication based at least in part on applying a cyclic shift, from a set of cyclic shifts, to the information, wherein the PUCCH communication is associated with multiple RBs, wherein a quantity of the multiple RBs is M, and wherein the set of cyclic shifts include cyclic shift values of 0, M, 3M, 4M, 6M, 7M, 9M, and 10M. The set of instructions, when executed by one or more processors of the UE, may cause the UE to transmit, based at least in part on processing the information, the PUCCH communication including the information.

Some aspects described herein relate to a non-transitory computer-readable medium that stores a set of instructions for wireless communication by a base station. The set of instructions, when executed by one or more processors of the base station, may cause the base station to receive, from a UE, a PUCCH communication that includes information, wherein the PUCCH communication is associated with multiple RBs. The set of instructions, when executed by one or more processors of the base station, may cause the base station to decode the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M.

Some aspects described herein relate to an apparatus for wireless communication. The apparatus may include means for processing, for a PUCCH communication, information to be included in the PUCCH communication based at least in part on applying a cyclic shift, from a set of cyclic shifts, to the information, wherein the PUCCH communication is associated with multiple RBs, wherein a quantity of the multiple RBs is M, and wherein the set of cyclic shifts include cyclic shift values of 0, M, 3M, 4M, 6M, 7M, 9M, and 10M. The apparatus may include means for transmitting, based at least in part on processing the information, the PUCCH communication including the information.

Some aspects described herein relate to an apparatus for wireless communication. The apparatus may include means for receiving, from a UE, a PUCCH communication that includes information, wherein the PUCCH communication is associated with multiple RBs. The apparatus may include means for decoding the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a slot format, in accordance with the present disclosure.

FIG. 4 is a diagram illustrating an example of physical channels and reference signals in a wireless network, in accordance with the present disclosure.

FIG. 5 is a diagram of an example associated with cyclic shifts for multiple resource block (RB) physical uplink control channel (PUCCH) communications, in accordance with the present disclosure.

FIGS. 6 and 7 are diagrams illustrating examples associated with different cyclic shift options for multiple RB PUCCH communications, in accordance with the present disclosure.

FIGS. 8 and 9 are diagrams illustrating example processes associated with cyclic shifts for multiple RB PUCCH communications, in accordance with the present disclosure.

FIGS. 10 and 11 are diagrams of example apparatuses for wireless communication, in accordance with the present disclosure.

FIG. 12 is a diagram illustrating an example disaggregated base station architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

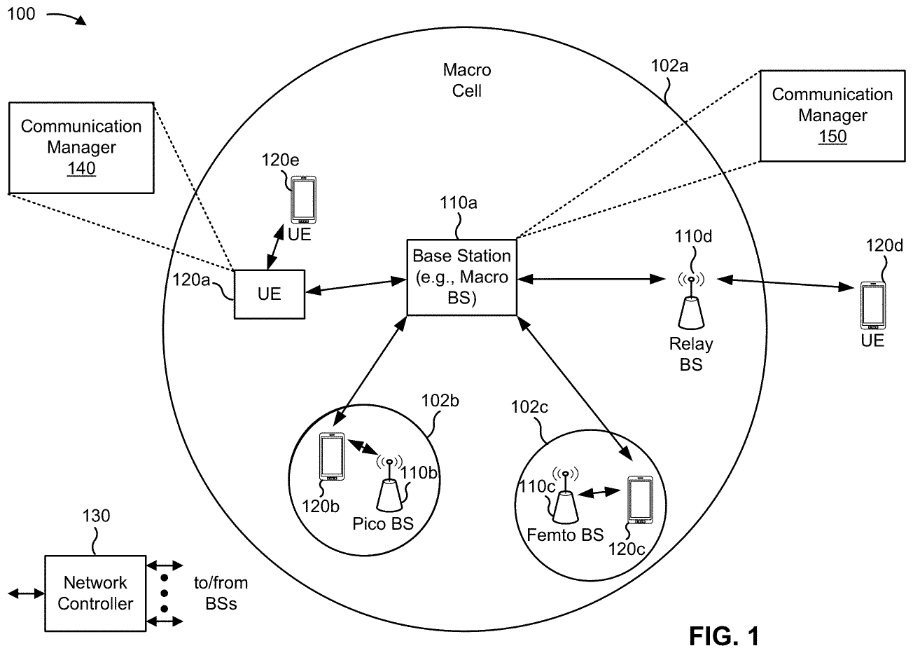

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may process, for a physical uplink control channel (PUCCH) communication, information to be included in the PUCCH communication based at least in part on applying a cyclic shift, from a set of cyclic shifts, to the information, wherein the PUCCH communication is associated with multiple resource blocks (RBs), wherein a quantity of the multiple RBs is M, and wherein the set of cyclic shifts include cyclic shift values of 0, M, 3M, 4M, 6M, 7M, 9M, and 10M; and transmit, based at least in part on processing the information, the PUCCH communication including the information. Additionally, or alternatively, the communication manager 140 may perform one or more other operations described herein.

In some aspects, the base station 110 may include a communication manager 150. As described in more detail elsewhere herein, the communication manager 150 may receive, from a UE, a PUCCH communication that includes information, wherein the PUCCH communication is associated with multiple RBs; and decode the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M. Additionally, or alternatively, the communication manager 150 may perform one or more other operations described herein.

As indicated above, FIG. 1 is provided as an example. Other examples may differ from what is described with regard to FIG. 1.

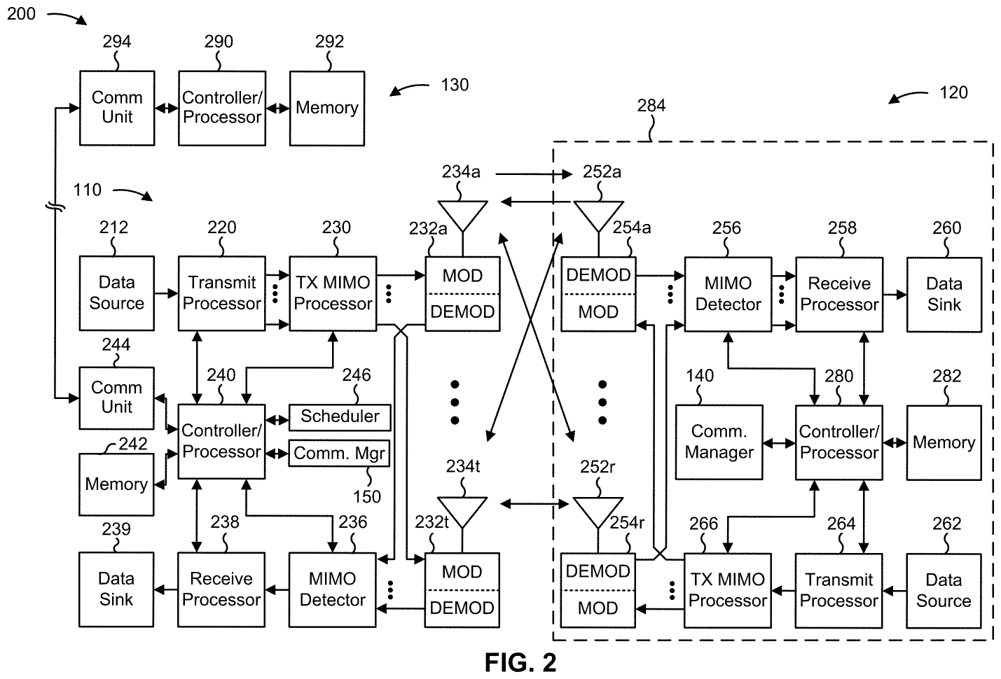

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

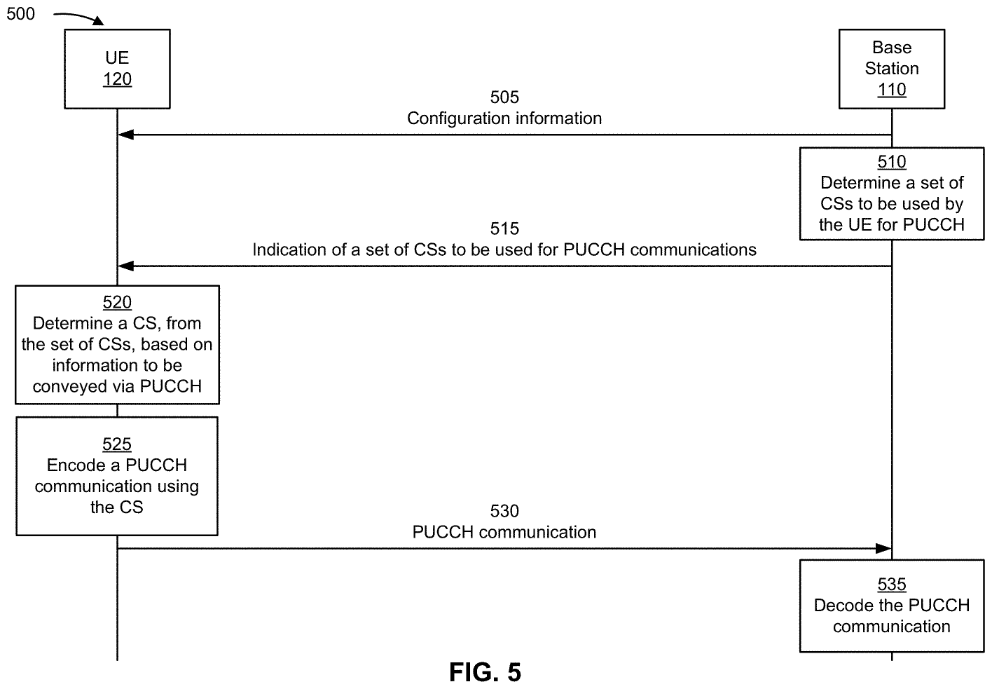

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

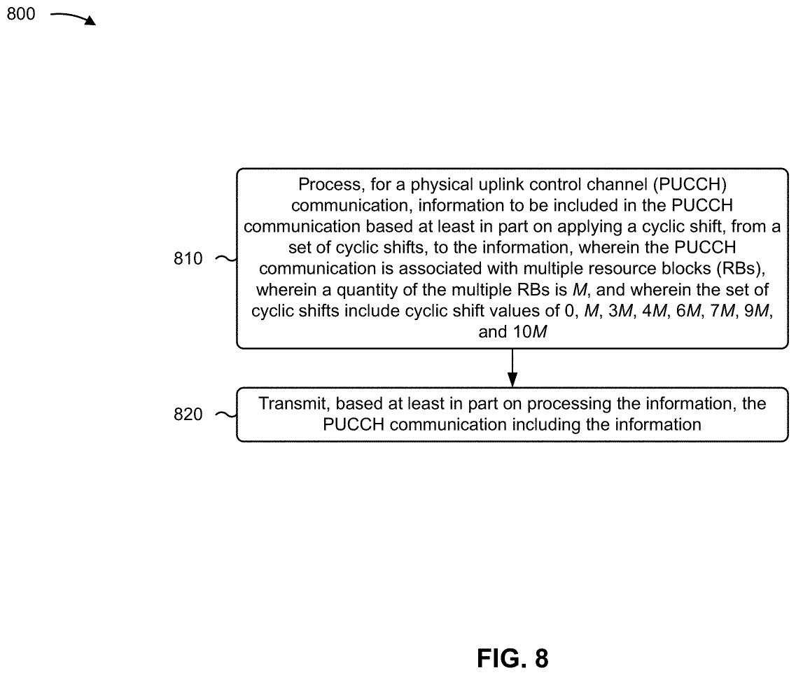

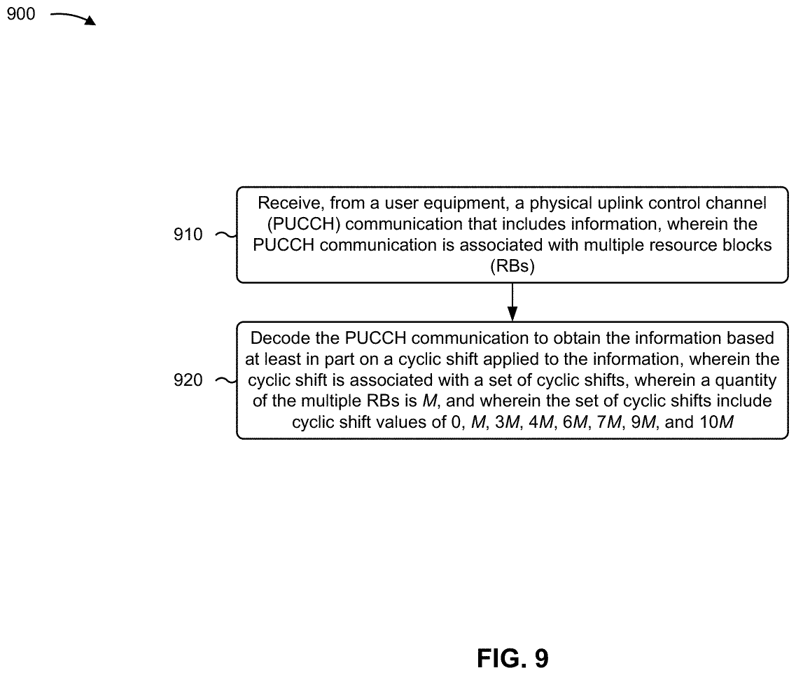

The controller/processor 240 of the base station 110, the controller/processor 280 of the UE 120, and/or any other component(s) of FIG. 2 may perform one or more techniques associated with cyclic shifts for multiple RB PUCCH communications, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for processing, for a PUCCH communication, information to be included in the PUCCH communication based at least in part on applying a cyclic shift, from a set of cyclic shifts, to the information, wherein the PUCCH communication is associated with multiple RBs, wherein a quantity of the multiple RBs is M, and wherein the set of cyclic shifts include cyclic shift values of 0, M, 3M, 4M, 6M, 7M, 9M, and 10M; and/or means for transmitting, based at least in part on processing the information, the PUCCH communication including the information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for receiving, from a UE, a PUCCH communication that includes information, wherein the PUCCH communication is associated with multiple RBs; and/or means for decoding the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

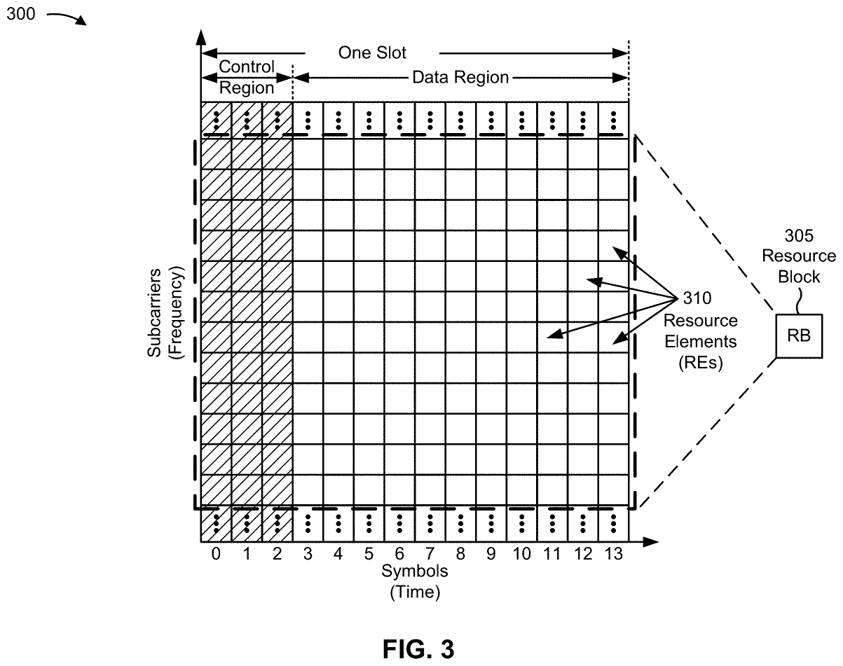

FIG. 3 is a diagram illustrating an example 300 of a slot format, in accordance with the present disclosure. As shown in FIG. 3, time-frequency resources in a radio access network may be partitioned into resource blocks, shown by a single RB 305. An RB 305 is sometimes referred to as a physical resource block (PRB). An RB 305 includes a set of subcarriers (e.g., 12 subcarriers) and a set of symbols (e.g., 14 symbols) that are schedulable by a base station 110 as a unit. In some aspects, an RB 305 may include a set of subcarriers in a single slot. As shown, a single time-frequency resource included in an RB 305 may be referred to as a resource element (RE) 310. An RE 310 may include a single subcarrier (e.g., in frequency) and a single symbol (e.g., in time). A symbol may be referred to as an orthogonal frequency division multiplexing (OFDM) symbol. An RE 310 may be used to transmit one modulated symbol, which may be a real value or a complex value.

In some telecommunication systems (e.g., NR), RBs 305 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As indicated above, FIG. 3 is provided as an example. Other examples may differ from what is described with respect to FIG. 3.

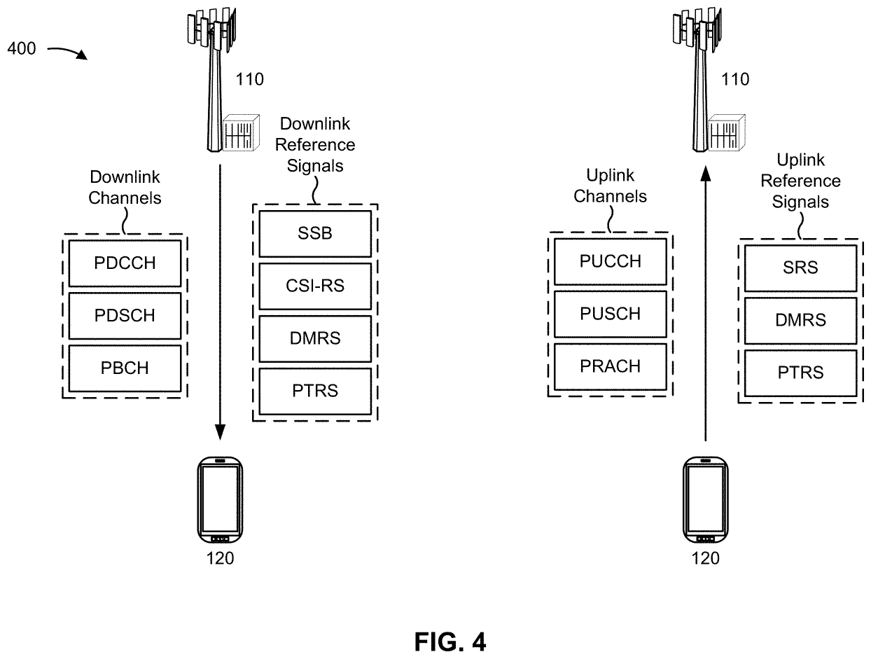

FIG. 4 is a diagram illustrating an example 400 of physical channels and reference signals in a wireless network, in accordance with the present disclosure. As shown in FIG. 4, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a PUCCH that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

The PUCCH may be used to convey different types of payload data, such as a scheduling request (SR) or a hybrid automatic repeat request (HARQ) feedback message, among other examples. For example, the PUCCH may include a 1 bit SR in PUCCH format 0 that overlaps (e.g., in terms of time resources) with a 1 or 2 bit HARQ ACK message in PUCCH format 0. Different messages included in the PUCCH may be associated with different priorities. For example, the 1 bit SR may have a relatively high priority and the 1 or 2 bit HARQ-ACK may have a relatively low priority. Similarly, the 1 or 2 bit HARQ ack may have a relatively high priority and the 1 bit SR may have a relatively low priority. Other types of payload may be possible with other types or levels of priority. Additionally, combinations of payloads may be possible. For example, the PUCCH may convey a first payload at a first frequency that includes first bits of a message with a first priority and may convey a second payload at a second frequency that includes second bits of the message with a second priority.

The UE 120 may transmit PUCCH messages (e.g., a message on the PUCCH) using different PUCCH formats. In some cases, PUCCH formats may be defined, or otherwise fixed, by a wireless communication standard, such as the 3GPP. A PUCCH format may include a PUCCH format 0, a PUCCH format 1, a PUCCH format 2, a PUCCH format 3, or a PUCCH format 4. The PUCCH format 0 may be associated with 1 or 2 OFDM symbols and a payload size of 1 or 2 bits. The PUCCH format 1 may be associated with 4 to 14 OFDM symbols and a payload size of 1 or 2 bits. The PUCCH format 2 may be associated with 1 or 2 OFDM symbols and a payload size of more than 2 bits. The PUCCH format 3 may be associated with 4 to 14 OFDM symbols and a payload size of more than 2 bits. The PUCCH format 4 may be associated with 4 to 14 OFDM symbols and a payload size of more than 2 bits.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

In some cases, a UE may transmit a PUCCH message using a single RB with a particular base sequence at the single RB with a particular amount of cyclic shift (CS). For example, a UE may transmit a 1 bit SR using a PUCCH format 0 using a base sequence S in 1 RB and with a particular CS. In such examples, the particular CS may be a CS value between 0 and 11 (e.g., 12 discrete CS values may be permitted because there are 12 subcarriers or 12 REs in the single RB). Out of the set of possible CSs, the base station may transmit a radio resource control (RRC) message to a UE to indicate which CS index i the UE is to use to convey each possible value for a message that the UE is to transmit on the PUCCH. For example, the base station may configure the UE to use a CS value of 0 to indicate a positive SR and to transmit nothing to indicate a negative SR. In some other aspects, the mapping between CS index i and a possible value for a message may be defined, or otherwise fixed, by a wireless communication standard, such as the 3GPP (e.g., the mapping may be hardcoded on a UE and may not be configured by a base station).

When there are a plurality of possible values that the UE is to convey via use of a CS value, the base station may select CS values that are approximately equidistant with respect to the set of possible CS values. For example, the base station may configure the UE to transmit a one bit HARQ feedback message by using a CS value of 0 (e.g., out of the possible CS values 0 to 11) to indicate a first value for the HARQ feedback message (e.g., an ACK/NACK value (A/N value) a value of “{0}”) and a CS value of 6 to indicate a second value for the HARQ feedback message (e.g., an A/N value of “{1}”). For 2 bit HARQ feedback, the base station may configure the UE to use the CS value of 0 (e.g., of the possible CS values 0 to 11) for a first A/N value “{0, 0}”, the CS value of 3 for a second A/N value “{0, 1}”, the CS value of 6 for a third A/N value “{1, 0}”, and the CS value of 9 for a fourth A/N value “{1, 0}”. Other types of payload, values for the payload, or configurations of CS values may be possible. By selecting CS values that are approximately equidistant with respect to the set of possible CS values, the base station maximizes a gap or spacing between different selected CS values, which increases a likelihood that the base station can successfully decode the PUCCH message from the UE.

When the UE is to convey a plurality of payloads with the same priority, the base station may configure the UE with a plurality of sets of CS values to convey the plurality of payloads. For example, when the UE is to convey both an SR and a HARQ feedback message, the UE may be configured to use a first set of CS values (e.g., 0 and 6) to indicate a negative SR and may select a first CS value from the first set of CS values (e.g., 0) to indicate an A/N value of “{0}” and a second CS value from the first set of CS values (e.g., 6) to indicate an A/N value of “{1}”. In contrast, the UE may use a second set of CS values (e.g., 3 and 9) to indicate a positive SR and may select a first CS value from the second set of CS values (e.g., 3) to indicate an A/N value of “{0}” and a second CS value from the second set of CS values (e.g., 9) to indicate an A/N value of “{1}”. As used herein, “positive SR” may refer to an SR that indicates a request for resources for a subsequent uplink transmission. “Negative SR” may refer to an SR that is not indicating a request for resources for a subsequent uplink transmission (e.g., that indicates that no resources are needed). In other words, a positive SR may indicate that a UE is requesting resources, whereas a negative SR may indicate that the UE does not currently need resources for future uplink transmissions.

In another example, for 2 bit HARQ feedback, the UE may be configured with a first set of CS values (e.g., 0, 3, 6, 9) that are to be used to indicate a negative SR and the UE may select one CS value from the first set of CS values to indicate which A/N value is also being indicated. The UE may be configured with a second set of CS values (e.g., 1, 4, 7, 10) to be used to indicate a positive SR and the UE may select one of the second set of CS values to indicate which A/N value is also being indicated. In such examples, CS values within each set of CS values are approximately equidistant (e.g., 0, 3, 6, and 9 are equidistant with respect to CS values 0 to 11, as are 1, 4, 7, and 10), but, as a result, a spacing between each whole set of CS values is relatively small (e.g., 0 and 1 are adjacent, and 3 and 4 are adjacent, among other examples).

In some communications systems, such as in NR unlicensed spectrum in higher frequency bands (e.g., millimeter wave bands, such as approximately 60 gigahertz (GHz) or 52-71 GHz), a power spectral density (PSD) limit is applicable to transmissions. For example, a transmitter may limit a transmission to 23 decibel-milliwatts (dBm) per megahertz (MHz) with up to a maximum of 40 dBm effective isotropic radiated power (EIRP). To fully utilize available power for a high-EIRP-capable device, the high-EIRP-capable device may occupy at least a 50 MHz transmission bandwidth, which may enable the high-EIRP-capable device to achieve up to 40 dBm under the 23 dBm/MHz PSD limitation.

During transmission of a PUCCH message, a UE may occupy a particular amount of available bandwidth. For example, for a 120 kilohertz (kHz) subcarrier spacing (SCS) for a PUCCH format 0, 1, or 4, the transmitter may occupy 1 RB in a frequency domain, which may result in a total occupied bandwidth of 1.44 MHz. In contrast, for a 120 kHz SCS with a PUCCH format 2 or 3, the transmitter may occupy up to 16 RBs in the frequency domain, which may result in a total occupied bandwidth of approximately 23 MHz. Similarly, for a 960 kHz SCS, with a PUCCH format 0, 1, or 4, a total occupied bandwidth may be approximately 12 MHz. Accordingly, a total occupied bandwidth may be insufficient to make full use of available transmission power, which may result in reduced communication performance relative to using all available transmission power.

In some cases, to operate in the higher frequency bands, a UE may be enabled to transmit a PUCCH message that occupies multiple RBs (e.g., a multi-RB PUCCH message). For example, the UE may be enabled to use the PUCCH format 0, PUCCH format 1, or PUCCH format 4 to transmit multi-RB PUCCH messages. For the PUCCH format 0, a PUCCH message may occupy up to 16 RBs (e.g., for SCSs of 120 kHz, 480 KHz, or 960 KHz). For example, the PUCCH message may occupy a set of M contiguous RBs. The UE may use a base sequence of length 12*M to process information for transmission using the set of M contiguous RBs. As an example, for PUCCH communications of PUCCH format 0 described above, UEs may use cyclic shifts of 0, 3, 6, or 9 for HARQ ACK or NACK feedback. Further, the UEs may use a cyclic shift of 1, 4, 7, or 10 for indicating a positive SR when SRs are multiplexed into the PUCCH resources. In PUCCH communication with a set of M contiguous RBs, UE 120 may further use additional values for the cyclic shift. As described in 3GPP Technical Specification (TS) 38.211, Release 16, Version 16.4.0, § 5.2.2, the base sequence may be defined by an equation:

$${\overline{r}}_{u , v} ( n ) = {e}^{j π φ ( n ) / 4} ; 0 \leq n < 12 M - 1 ; M < 3 \\ {\overline{r}}_{u , v} ( n ) = {x}_{q} ( n mod {N}_{ZC} ) ; M \geq 3 \\ {x}_{q} ( m ) = exp ( - \frac{j π qm ( m + 1 )}{{N}_{NC}} )$$

where r̅_{u,v} represents a base sequence for an index n and N_{zc} represents a length of a Zadoff-Chu (ZC) sequence, which, for M=34 is 401. Here, a UE may determine a cyclic shift based at least in part on an equation:

$$α = \frac{2 π}{12 M} ( ( {m}_{0} + {m}_{cs} + {m}_{int} + {n}_{cs} ( {n}_{s , f , l}^{μ} + {l}^{′} ) ) mod 12 M )$$

where α represents a cyclic shift value, m₀ represents an initial cyclic shift, m_{cs} represents an information content cyclic shift, mᵢₙₜ represents an interlace cyclic shift, and n_{cs}(n_{s,f,l}^{μ}+l′) represents a pseudo-random sequence function. Previously, the UE may select the value for m₀ from the set {0, 1, . . . , 12M−1} to enable multiplexing with other UEs. Similarly, UE 120 may select the value for m_{cs} based at least in part on a fixed mapping. For example, for PUCCH format 0 with one HARQ information bit, the UE may select 0 to represent a NACK or 6M to represent an ACK. Similarly, for PUCCH format 0 with two HARQ information bits, UE 120 may select a 0 to represent a NACK-NACK, 3M to represent a NACK-ACK, 6M to represent an ACK-ACK, or 9M to represent an ACK-NACK. Similarly, for PUCCH format 0 with two HARQ information bits and an SR, UE 120 may select similar cyclic shifts as for two HARQ information bits without an SR to represent the two HARQ information bits with a negative SR, and may add a value of └3M/2┘, to the aforementioned cyclic shifts to represent two HARQ information bits with a positive SR.

Therefore, as described above, a total number of available CS values for multi-RB PUCCH messages increases to 12M (e.g., from 12 when a single RB is used to transmit the PUCCH messages). As a result, there are an increased number of options for the CS values to be used by the UE. However, a fixed, static, or “one size fits all” approach for mapping of values of a CS (e.g., for the m_{cs}) to content or information bit(s) indicated by the PUCCH communication may be inefficient. For example, in some cases, a base station may perform multiplexing to receive PUCCH communications from multiple UEs at the same, or approximately the same time. In other cases, the base station may not need to perform multiplexing and may receive a PUCCH communication from a single UE at a given time. For example, a first mapping of CS values to different content (e.g., a mapping of a CS value to represent ACK or NACK and/or to represent a positive SR or a negative SR) may improve decoding performance of PUCCH communications at the base station when the base station receives a PUCCH communication from a single UE at a given time. However, the first mapping may be associated with degraded decoding performance at the base station when the base station is performing multiplexing to receive PUCCH communications from multiple UEs at the same, or approximately the same time. A second mapping of CS values to different content may improve decoding performance at the base station when the base station is performing multiplexing to receive PUCCH communications from multiple UEs at the same, or approximately the same time, but may be associated with degraded decoding performance of PUCCH communications at the base station when the base station receives a PUCCH communication from a single UE at a given time (e.g., as compared to the first mapping). Therefore, using a fixed, static, or “one size fits all” approach for mapping of values of a CS (e.g., for the m_{cs}) to content or information bit(s) conveyed by the PUCCH communication may result in degraded decoding performance at the base station in different scenarios.

Some techniques and apparatuses described herein enable cyclic shifts for multiple RB PUCCH communications. In some examples, some techniques and apparatuses described herein provide improved cyclic shifts for multiple RB PUCCH communications when a base station is performing PUCCH multiplexing. For example, a set of CSs to be used by a UE to represent different information bits may be configured such that a separation (for example, a number of RBs) between CSs used by different UEs is increased or maximized to improve decoding performance at the base station when the base station is performing PUCCH multiplexing to receive PUCCH communications from the different UEs at the same, or approximately the same, time. For example, the set of CSs may include CS values of 0, M, 3M, 4M, 6M, 7M, 9M, and 10M, where M is a quantity of RBs associated with the PUCCH communication. The UE may select a CS, from the set of CSs, based at least in part on a content of information to be conveyed via a multi-RB PUCCH communication. The set of CSs may be associated with multi-RB PUCCH communications that use a PUCCH format 0. As described herein, a CS selected or applied by the UE may refer to the information content cyclic shift (e.g., the m_{cs}).

For example, the PUCCH communication may be a 2-bit ACK/NACK message with an SR. In some aspects, a first subset of the CS values may be associated with indicating a negative SR and a second subset of the CS values may be associated with indicating a positive SR. For example, the CS values of 0, 3M, 6M, and 9M may be associated with indicating a negative SR. In other words, the UE may select a CS from the CS values of 0, 3M, 6M, and 9M when the SR to be indicated is a negative SR (e.g., where the CS selected is based at least in part on the 2-bit ACK/NACK indication to be conveyed). For example, a CS value of 0 may be selected to represent a negative SR and a NACK-NACK (e.g., a first bit indicating NACK and a second bit indicating NACK). A CS value of 3M may be selected to represent a negative SR and a NACK-ACK (e.g., a first bit indicating NACK and a second bit indicating ACK). A CS value of 6M may be selected to represent a negative SR and an ACK-ACK (e.g., a first bit indicating ACK and a second bit indicating ACK). A CS value of 9M may be selected to represent a negative SR and an ACK-NACK (e.g., a first bit indicating ACK and a second bit indicating NACK). Similarly, the UE may select a CS from the CS values of M, 4M, 7M, and 10M when the SR to be indicated is a positive SR (e.g., where the CS selected is based at least in part on the 2-bit ACK/NACK indication to be conveyed). For example, a CS value of M may be selected to represent a positive SR and a NACK-NACK. A CS value of 4M may be selected to represent a positive SR and a NACK-ACK. A CS value of 7M may be selected to represent a positive SR and an ACK-ACK. A CS value of 10M may be selected to represent a positive SR and an ACK-NACK.

The UE may apply the selected CS to the information to be included in the PUCCH communication. The UE may transmit, and the base station may receive, the PUCCH communication including the information (e.g., based at least in part on the UE processing the information and/or applying the selected CS, as described above). The base station may perform blind decoding by applying one or more hypothesis to identify the CS applied by the UE. Based at least in part on the CS identified by the base station, the base station may determine the information conveyed by the PUCCH communication. For example, if the base station identifies that the CS applied to the PUCCH communication is M, then the base station may determine that the PUCCH is conveying a positive SR and a NACK-NACK. Because of the CS values included in the set of CS values available to be selected by the UE, the CSs used by the UE may be grouped closer together (e.g., than if approximately equidistant CS values were included in the set of CSs). As a result, a distance (e.g., in terms of a quantity of CSs) between a CS used by one UE and a CS used by another UE may be increased, thereby improving a decoding performance at the base station when the base station is performing PUCCH multiplexing. In other words, because of the CS values (e.g., of 0, M, 3M, 4M, 6M, 7M, 9M, and 10M) included in the set of CSs, a decoding performance of a base station may be improved when the base station is multiplexing PUCCH communications associated with multiple RBs.

Additionally, some techniques and apparatuses described herein provide dynamic CSs for multi-RB PUCCH communications. For example, there may be multiple sets of CSs associated with conveying information in multi-RB PUCCH communications. A first set of CSs may be associated with the set of CSs described above (e.g., associated with improving decoding performance at the base station when the base station is performing PUCCH multiplexing). A second set of CSs may also be available to be used by the UE and/or the base station. For example, the second set of CSs may include CS values that are approximately equidistantly spaced. For example, the second set of CSs may include CS values of 0, └3M/2┘, 3M, └9M/2┘, 6M, └15M/2┘, 9M, and └21M/2┘. If the second set of CS values are used by the UE and/or the base station, then the UE may select and apply a CS, from the second set of CSs, to represent and/or convey information bits based at least in part on a content of the information associated with a multi-RB PUCCH communication (e.g., in a similar manner as described elsewhere herein). For example, CS values of 0, 3M, 6M, and 9M may be associated with representing a negative SR and CS values of └3M/2┘, └9M/2┘, └15M/2┘, and └21M/2┘ may be associated with representing a positive SR. The second set of CS values may improve decoding performance at the base station when the base station is receiving a multi-RB PUCCH communication from a single UE at a given time (e.g., and not performing PUCCH multiplexing).

In some aspects, the base station may transmit, and the UE may receive, an indication of a set of CSs, from the first set of CSs and the second set of CSs (and/or other sets of CSs), to be used and/or applied by the UE. For example, the base station may dynamically configure the UE to use a given set of CSs that is selected by the base station from multiple sets of CSs. For example, the base station may select the given set of CSs based at least in part on decoding operations performed by the base station. For example, if the base station is performing PUCCH multiplexing, then the base station may configure the UE to use the first set of CSs described above (e.g., that include CS values of 0, M, 3M, 4M, 6M, 7M, 9M, and 10M). If the base station is not performing PUCCH multiplexing and/or to improve the decoding performance for particular UE, the base station may configure the UE to use the second set of CSs described above (e.g., that include CS values of 0, └3M/2┘, 3M, └9M/2┘, 6M, └15M/2┘, 9M, and └21M/2┘). This may provide additional flexibility for the base station and/or the UE to use different options or different sets of CSs for multi-RB PUCCH communications in different conditions and/or different scenarios. In some aspects, the base station may transmit, and the UE may receive, the indication of a set of CSs, from the first set of CSs and the second set of CSs (and/or other sets of CSs), to be used and/or applied by the UE via RRC signaling or another type of signaling. For example, an RRC parameter or an RRC flag may indicate which option or which set of CSs is to be applied by the UE for multi-RB PUCCH communications that use the PUCCH format 0. In this way, the base station may dynamically configure the UE to use different options or different sets of CSs for transmitting multi-RB PUCCH communications.

FIG. 5 is a diagram of an example 500 associated with cyclic shifts for multiple RB PUCCH communications, in accordance with the present disclosure. As shown in FIG. 5, a base station 110 may communicate with a UE 120. In some aspects, the base station 110 and the UE 120 may be part of a wireless network (e.g., the wireless network 100). In some aspects, actions described as being performed by the base station 110 may be performed by multiple different network nodes. For example, configuration actions may be performed by a first network node (e.g., a central unit (CU) and/or a distributed unit (DU)), and radio communication actions may be performed by a second network node (e.g., a DU and/or a radio unit (RU)). The UE 120 and the base station 110 may have established a wireless connection prior to operations shown in FIG. 5.

As shown by reference number 505, the network node may transmit (directly or via one or more other network nodes), and the UE may receive, configuration information. In some aspects, the UE may receive the configuration information via one or more of RRC signaling, one or more medium access control (MAC) control elements (MAC-CEs), and/or DCI, among other examples. In some aspects, the configuration information may include an indication of one or more configuration parameters (e.g., stored by the UE 120 and/or previously indicated by base station 110 or other network device) for selection by the UE 120, and/or explicit configuration information for the UE 120 to use to configure itself, among other examples.

In some aspects, the configuration information may configure one or more sets of CS values that are available to be used by the UE 120 for encoding PUCCH communications. For example, the configuration information may indicate a configuration for multiple RB PUCCH communications. In some aspects, the configuration information may include a PUCCH configuration that indicates that the UE 120 is configured to transmit multiple RB PUCCH communications, as described elsewhere herein.

In some aspects, the configuration information may indicate that the UE 120 is to convey content via the multi-RB PUCCH communications. For example, the information or content to be conveyed may include ACK/NACK (e.g., HARQ ACK/NACK) feedback and a scheduling request, among other examples. In some aspects, the ACK/NACK feedback may be associated with a size of 2 bits (e.g., two bit HARQ-ACK information or two HARQ-ACK information bits). The scheduling request may be associated with a size of 1 bit (e.g., a single SR information bit).

In some aspects, the configuration information may indicate that the UE 120 is to receive an indication of a set of CS values, from multiple available sets of CS values, to be used by the UE 120. In other words, the configuration information may indicate that the UE 120 is to receive a dynamic indication of a set of CS values to be used by the UE 120 to convey information via a multi-RB PUCCH communication. In some aspects, the configuration information may indicate the multiple available sets of CS values. In other aspects, the multiple available sets of CS values may be defined, or otherwise fixed, by a wireless communication standard, such as the 3GPP. In such examples, the UE 120 may not receive an indication or configuration of the multiple available sets of CS values.

In some aspects, the multiple available sets of CS values may be associated with a certain PUCCH format, such as PUCCH format 0. For example, the UE 120 may receive an indication of the first set of cyclic shifts and a second set of cyclic shifts, where the first set of cyclic shifts and the second set of cyclic shifts are associated with multiple RB PUCCH communications that are associated with a PUCCH format 0.

The UE 120 may configure itself based at least in part on the configuration information. In some aspects, the UE 120 may be configured to perform one or more operations described herein based at least in part on the configuration information.

As shown by reference number 510, the base station 110 may determine a set of CS values, from multiple available sets of CS values, to be used by the UE 120. The determination of the set of CS values may be based at least in part on decoding operations performed by the base station 110. For example, if the base station 110 is performing PUCCH multiplexing, then the base station 110 may configure the UE 120 to use the first set of CS values (e.g., that include CS values of 0, M, 3M, 4M, 6M, 7M, 9M, and 10M). If the base station 110 is not performing PUCCH multiplexing and/or to improve the decoding performance for the UE 120, then the base station 110 may configure the UE 120 to use a second set of CS values (e.g., that include CS values of 0, └3M/2┘, 3M, └9M/2┘, 6M, └15M/2┘, 9M, and └21M/2┘).

As shown by reference number 515, the base station 110 may transmit, and the UE 120 may receive, an indication of a set of CSs (e.g., a set of CS values) to be used by the UE 120 for PUCCH communications (e.g., for multi-RB PUCCH communications). In some aspects, the indication of the set of CSs may be included in the configuration information (e.g., received by the UE 120 as described above in connection with reference number 505). In some aspects, the indication of the set of CSs may be included in a separate communication (e.g., an RRC communication, a MAC-CE communication, and/or a DCI communication). For example, an RRC parameter (e.g., an RRC flag) may configure which set of CSs, from the multiple available sets of CSs, is to be used and/or applied by the UE 120.

For example, there may be multiple sets of CSs associated with conveying information in multi-RB PUCCH communications. A first set of CSs may be associated with the set of CSs described above (e.g., associated with improving decoding performance at the base station when the base station is performing PUCCH multiplexing). A second set of CSs may also be available to be used by the UE and/or the base station. For example, the second set of CSs may include CS values that are approximately equidistantly spaced. For example, the second set of CSs may include CS values of 0, └3M/2┘, 3M, └9M/2┘, 6M, └15M/2┘, 9M, and └21M/2┘. If the second set of CS values are used by the UE 120 and/or the base station 110, then the UE 120 may select and apply a CS, from the second set of CSs, to represent and/or convey information bits based at least in part on a content of the information associated with a multi-RB PUCCH communication (e.g., in a similar manner as described elsewhere herein). For example, CS values of 0, 3M, 6M, and 9M may be associated with representing a negative SR and CS values of └3M/2┘, └9M/2┘, └15M/2┘, and └21M/2┘ may be associated with representing a positive SR. The second set of CS values may improve decoding performance at the base station 110 when the base station 110 is receiving a multi-RB PUCCH communication from a single UE at a given time (e.g., and not performing PUCCH multiplexing).

In some aspects, the base station 110 may transmit, and the UE 120 may receive, the indication of a set of CSs, from the first set of CSs and the second set of CSs (and/or other sets of CSs), to be used and/or applied by the UE 120. For example, the base station 110 may dynamically configure the UE 120 to use a given set of CSs that is selected by the base station 110 from multiple sets of CSs. For example, the base station 110 may select the given set of CSs based at least in part on decoding operations performed by the base station (e.g., as described above in connection with reference number 510). For example, if the base station is performing PUCCH multiplexing, then the base station may configure the UE to use the first set of CSs described above (e.g., that include CS values of 0, M, 3M, 4M, 6M, 7M, 9M, and 10M). If the base station is not performing PUCCH multiplexing and/or to improve the decoding performance for a particular UE, the base station may configure the UE to use the second set of CSs described above (e.g., that include CS values of 0, └3M/2┘, 3M, └9M/2┘, 6M, └15M/2┘, 9M, and └21M/2┘). This may provide additional flexibility for the base station and/or the UE to use different options or different sets of CSs for multi-RB PUCCH communications in different conditions and/or different scenarios. In some aspects, the base station may transmit, and the UE may receive, the indication of a set of CSs, from the first set of CSs and the second set of CSs (and/or other sets of CSs), to be used and/or applied by the UE via RRC signaling or another type of signaling. For example, an RRC parameter or an RRC flag may indicate which option or which set of CSs is to be applied by the UE for multi-RB PUCCH communications that use the PUCCH format 0. In this way, the base station 110 may dynamically configure the UE 120 to use different options or different sets of CSs for transmitting multi-RB PUCCH communications.

As shown by reference number 520, the UE 120 may determine a CS (e.g., a CS value), from the set of CSs (e.g., indicated to the UE 120) based at least in part on information or content to be conveyed via a PUCCH communication. For example, the information may include HARQ-ACK feedback (e.g., ACK/NACK value(s)) and an SR. For example, the PUCCH communication may be a 2-bit ACK/NACK message with an SR. In some aspects, a first subset of the CS values may be associated with indicating a negative SR, and a second subset of the CS values may be associated with indicating a positive SR. For example, where the first set of CS values (e.g., 0, M, 3M, 4M, 6M, 7M, 9M, and 10M) are used by the UE 120, the CS values of 0, 3M, 6M, and 9M may be associated with indicating a negative SR. In other words, the UE may select a CS from the CS values of 0, 3M, 6M, and 9M when the SR to be indicated is a negative SR (e.g., where the CS selected is based at least in part on the 2-bit ACK/NACK indication to be conveyed). For example, a CS value of 0 may be selected to represent a negative SR and a NACK-NACK (e.g., a first bit indicating NACK and a second bit indicating NACK). A CS value of 3M may be selected to represent a negative SR and a NACK-ACK (e.g., a first bit indicating NACK and a second bit indicating ACK). A CS value of 6M may be selected to represent a negative SR and an ACK-ACK (e.g., a first bit indicating ACK and a second bit indicating ACK). A CS value of 9M may be selected to represent a negative SR and an ACK-NACK (e.g., a first bit indicating ACK and a second bit indicating NACK). Similarly, the UE may select a CS from the CS values of M, 4M, 7M, and 10M when the SR to be indicated is a positive SR (e.g., where the CS selected is based at least in part on the 2-bit ACK/NACK indication to be conveyed). For example, a CS value of M may be selected to represent a positive SR and a NACK-NACK. A CS value of 4M may be selected to represent a positive SR and a NACK-ACK. A CS value of 7M may be selected to represent a positive SR and an ACK-ACK. A CS value of 10M may be selected to represent a positive SR and an ACK-NACK.

As another example, where the second set of CS values (e.g., 0, └3M/2┘, 3M, └9M/2┘, 6M, └15M/2┘, 9M, and └21M/2┘) are used by the UE 120, CS values of 0, 3M, 6M, and 9M may be associated with representing a negative SR and CS values of └3M/2┘, └9M/2┘, └15M/2┘, and └21M/2┘ may be associated with representing a positive SR. The second set of CS values may improve decoding performance at the base station 120 when the base station 110 is receiving a multi-RB PUCCH communication from a single UE at a given time (e.g., and not performing PUCCH multiplexing).

As shown by reference number 525, the UE 120 may process, for a PUCCH communication, information to be included in the PUCCH communication based at least in part on applying a cyclic shift, from a set of cyclic shifts, to the information. For example, the UE 120 may encode the PUCCH communication using the cyclic shift that is selected based at least in part on the information to be indicated by the PUCCH communication. For example, the PUCCH communication may be a multi-RB PUCCH communication. The set of cyclic shifts may include cyclic shift values of 0, M, 3M, 4M, 6M, 7M, 9M, and 10M. In other examples, set of cyclic shifts may include cyclic shift values of 0, └3M/2┘, 3M, └9M/2┘, 6M, └15M/2┘, 9M, and └21M/2┘.

As shown by reference number 530, the UE 120 may transmit, and the base station 110 may receive, the PUCCH communication (e.g., that is processed and/or encoded using the CS value selected by the UE 120). As shown by reference number 535, the base station 110 may decode the PUCCH communication. For example, the base station 110 may attempt blind decodings using hypotheses that are based at least in part on the set of CS values configured for, and/or indicated to, the UE 120. For example, the base station 110 may attempt to decode the PUCCH communication using one or more (or all) of the CS values included in the set of CS values configured for, and/or indicated to, the UE 120. The base station 110 may successfully decode the PUCCH communication using a CS value from the set of CS values (e.g., the CS value that was used to encode the PUCCH communication by the UE 120). The base station 110 may determine the information to be conveyed (e.g., HARQ-ACK values and/or a positive or negative SR) based at least in part on the CS value that enables the base station 110 to successfully decode the PUCCH communication.

As indicated above, FIG. 5 is provided as an example. Other examples may differ from what is described with respect to FIG. 5.

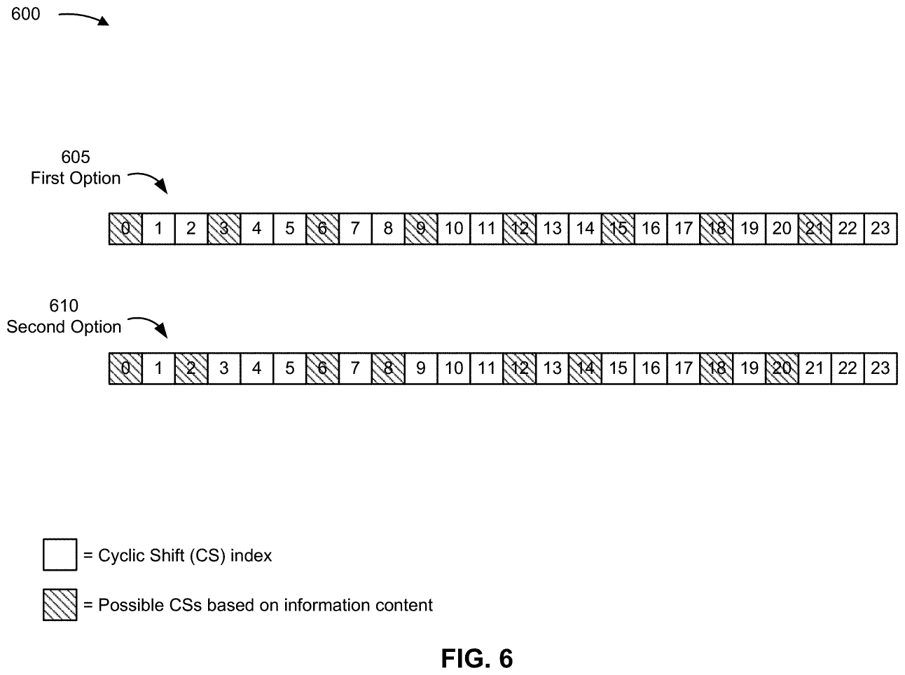

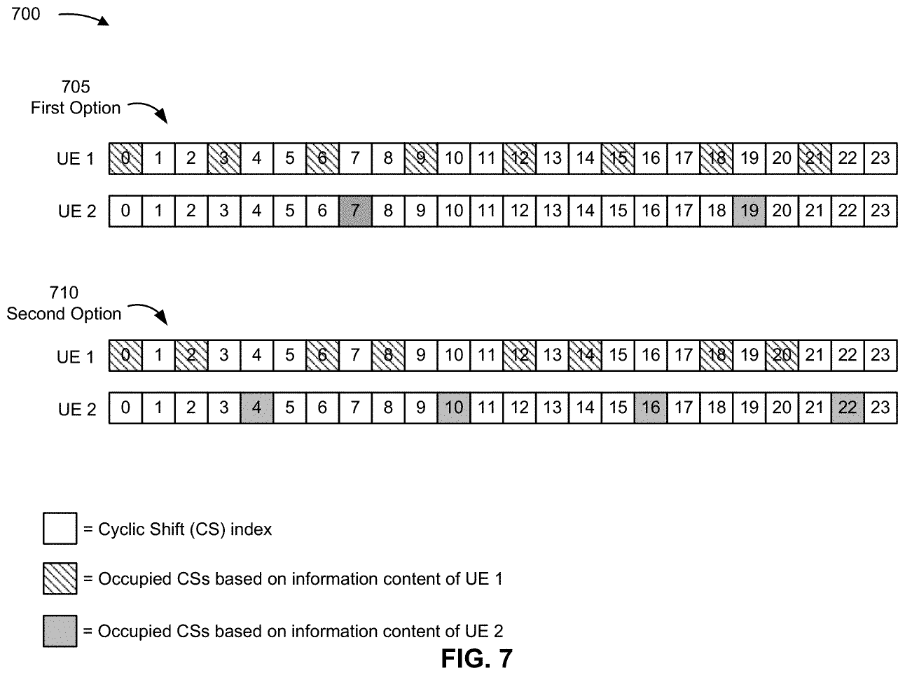

FIG. 6 is a diagram illustrating an example 600 associated with different cyclic shift options for multi-RB PUCCH communications, in accordance with the present disclosure. FIG. 6 depicts examples of different applied CSs for a first option 605 and a second option 610. The example 600 may be associated with a PUCCH communication that occupies 2 RBs (e.g., where M is equal to 2). The first option 605 may be associated with the second set of CSs described above (e.g., that include CS values of 0, └3M/2┘, 3M, └9M/2┘, 6M, └15M/2┘, 9M, and └21M/2┘). The second option 610 may be associated with the first set of CSs described above (e.g., that include CS values of 0, M, 3M, 4M, 6M, 7M, 9M, and 10M). FIG. 6 depicts different CS indices. For example, where M is equal to 2, there may be 24 possible CS values or CS indices (e.g., 0 to 23) that can be selected by the UE. As depicted in FIG. 6, the first option 605 may result in an increased distance (e.g., in terms of a quantity of CSs) between a CSs used by the UE as compared to the second option 610. For example, in the example 600 where M is equal to 2, there are at least 2 CSs between each CS in the first option 605. In some cases, there may only be 1 CS between each CS in the second option 610. Therefore, the first option 605 may result in improved decoding performance at a base station for a single UE. However, as described and depicted in connection with FIG. 7, the second option 610 may result in improved decoding performance at a base station if the base station is receiving PUCCH communications from multiple UEs at the same, or approximately the same time.

As indicated above, FIG. 6 is provided as an example. Other examples may differ from what is described with respect to FIG. 6.

FIG. 7 is a diagram illustrating an example 700 associated with different cyclic shift options for multi-RB PUCCH communications, in accordance with the present disclosure. FIG. 7 depicts examples of different applied CSs for a first option 705 and a second option 710. The example 700 may be associated with a PUCCH communication that occupies 2 RBs (e.g., where M is equal to 2). The first option 705 may be associated with the second set of CSs described above (e.g., that include CS values of 0, └3M/2┘, 3M, └9M/2┘, 6M, └15M/2┘, 9M, and └21M/2┘). The second option 710 may be associated with the first set of CSs described above (e.g., that include CS values of 0, M, 3M, 4M, 6M, 7M, 9M, and 10M).

As shown in FIG. 7, a first UE (e.g., UE 1) may transmit a 2-bit A/N message with an SR using the second set of CSs described above (e.g., in the first option 705) or the first set of CSs described above (e.g., in the second option 710). A second UE (e.g., UE 2) may be transmitting a PUCCH communication, such as a A/N message (e.g., 1 bit A/N message in the first option 705 and a 2-bit A/N message in the second option 710). A base station may receive the PUCCH communications from UE 1 and UE 2 at the same, or approximately the same time. For example, the base station may multiplex the PUCCH communications from UE 1 and UE 2. As depicted in FIG. 7, the second option 710 results in an increased distance (e.g., in terms of a quantity of CSs) between a CS used by UE 1 and a CS used by the UE 2 as compared to the first option 705. For example, in the first option 705, there may only be 1 CS difference between the CS used by UE 1 and UE 2 (e.g., regardless of an moused by UE 2). Therefore, the second option 710 may result in improved decoding performance at the base station for multi-RB PUCCH communications when the base station is performing PUCCH multiplexing. For example, even when UE 2 is transmitting a 2-bit A/N message, a CS used by the UE 2 is at least 2 CSs away from a CS used by the UE 1. This may improve the ability of the base station to identify which UE is using which CS (e.g., using blind decoding and/or different hypothesis).

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with cyclic shifts for multiple RB PUCCH communications.

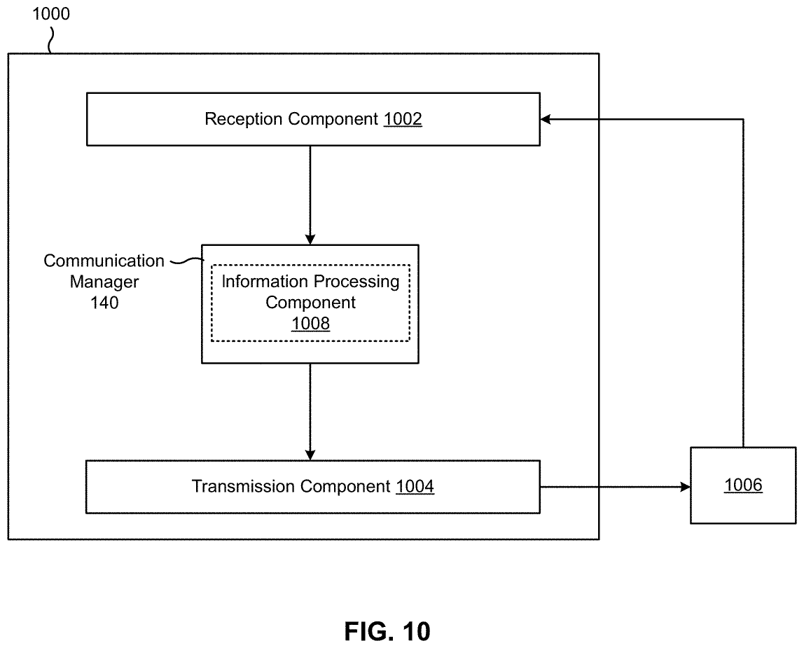

As shown in FIG. 8, in some aspects, process 800 may include processing, for a PUCCH communication, information to be included in the PUCCH communication based at least in part on applying a cyclic shift, from a set of cyclic shifts, to the information, wherein the PUCCH communication is associated with multiple RBs, wherein a quantity of the multiple RBs is M, and wherein the set of cyclic shifts include cyclic shift values of 0, M, 3M, 4M, 6M, 7M, 9M, and 10M (block 810). For example, the UE (e.g., using communication manager 140 and/or information processing component 1008, depicted in FIG. 10) may process, for a PUCCH communication, information to be included in the PUCCH communication based at least in part on applying a cyclic shift, from a set of cyclic shifts, to the information, wherein the PUCCH communication is associated with multiple RBs, wherein a quantity of the multiple RBs is M, and wherein the set of cyclic shifts include cyclic shift values of 0, M, 3M, 4M, 6M, 7M, 9M, and 10M, as described above.

As further shown in FIG. 8, in some aspects, process 800 may include transmitting, based at least in part on processing the information, the PUCCH communication including the information (block 820). For example, the UE (e.g., using communication manager 140 and/or transmission component 1004, depicted in FIG. 10) may transmit, based at least in part on processing the information, the PUCCH communication including the information, as described above.

Process 800 may include additional aspects, such as any single aspect or any combination of aspects described below and/or in connection with one or more other processes described elsewhere herein.

In a first aspect, the PUCCH communication is associated with a PUCCH format 0.

In a second aspect, alone or in combination with the first aspect, process 800 includes selecting the cyclic shift, from the set of cyclic shifts, based at least in part on a content of the information.

In a third aspect, alone or in combination with one or more of the first and second aspects, the information is associated with ACK/NACK feedback and a scheduling request.

In a fourth aspect, alone or in combination with one or more of the first through third aspects, the ACK/NACK feedback is associated with a size of 2 bits.

In a fifth aspect, alone or in combination with one or more of the first through fourth aspects, the information is associated with an SR, and wherein a first subset of cyclic shifts, from the set of cyclic shifts, is associated with indicating a positive SR, and wherein a second subset of cyclic shifts, from the set of cyclic shifts, is associated with indicating a negative SR.

In a sixth aspect, alone or in combination with one or more of the first through fifth aspects, the first subset of cyclic shifts include cyclic shift values of M, 4M, 7M, and 10M, and wherein the second subset of cyclic shifts include cyclic shift values of 0, 3M, 6M, and 9M.

In a seventh aspect, alone or in combination with one or more of the first through sixth aspects, the information is associated with a first bit associated with NACK feedback, a second bit associated with NACK feedback, and a negative scheduling request, and wherein the cyclic shift is 0.

In an eighth aspect, alone or in combination with one or more of the first through seventh aspects, the information is associated with a first bit associated with NACK feedback, a second bit associated with NACK feedback, and a positive scheduling request, and wherein the cyclic shift is M.

In a ninth aspect, alone or in combination with one or more of the first through eighth aspects, the information is associated with a first bit associated with NACK feedback, a second bit associated with ACK feedback, and a negative scheduling request, and wherein the cyclic shift is 3M.

In a tenth aspect, alone or in combination with one or more of the first through ninth aspects, the information is associated with a first bit associated with NACK feedback, a second bit associated with ACK feedback, and a positive scheduling request, and wherein the cyclic shift is 4M.

In an eleventh aspect, alone or in combination with one or more of the first through tenth aspects, the information is associated with a first bit associated with ACK feedback, a second bit associated with ACK feedback, and a negative scheduling request, and wherein the cyclic shift is 6M.

In a twelfth aspect, alone or in combination with one or more of the first through eleventh aspects, the information is associated with a first bit associated with ACK feedback, a second bit associated with ACK feedback, and a positive scheduling request, and wherein the cyclic shift is 7M.

In a thirteenth aspect, alone or in combination with one or more of the first through twelfth aspects, the information is associated with a first bit associated with ACK feedback, a second bit associated with NACK feedback, and a negative scheduling request, and wherein the cyclic shift is 9M.

In a fourteenth aspect, alone or in combination with one or more of the first through thirteenth aspects, the information is associated with a first bit associated with ACK feedback, a second bit associated with NACK feedback, and a negative scheduling request, and wherein the cyclic shift is 10M.

In a fifteenth aspect, alone or in combination with one or more of the first through fourteenth aspects, the set of cyclic shifts is a first set of cyclic shifts, and process 800 includes receiving, from a base station, an indication to use the first set of cyclic shifts, from the first set of cyclic shifts and a second set of cyclic shifts, for multiple RB PUCCH communications that are associated with a PUCCH format 0.

In a sixteenth aspect, alone or in combination with one or more of the first through fifteenth aspects, the indication to use the first set of cyclic shifts is received via RRC signaling.

In a seventeenth aspect, alone or in combination with one or more of the first through sixteenth aspects, the set of cyclic shifts is a first set of cyclic shifts, and process 800 includes receiving, from a base station, an indication of the first set of cyclic shifts and a second set of cyclic shifts, wherein the first set of cyclic shifts and the second set of cyclic shifts are associated with multiple RB PUCCH communications that are associated with a PUCCH format 0.

In an eighteenth aspect, alone or in combination with one or more of the first through seventeenth aspects, the set of cyclic shifts is a first set of cyclic shifts, and wherein a second set of cyclic shifts include cyclic shift values of 0, [3M/2], 3M, [9M/2], 6M, [15M/2], 9M, and [21M/2], and wherein the first set of cyclic shifts and the second set of cyclic shifts are associated with multiple RB PUCCH communications that are associated with a PUCCH format 0.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with cyclic shifts for multiple RB PUCCH communications.

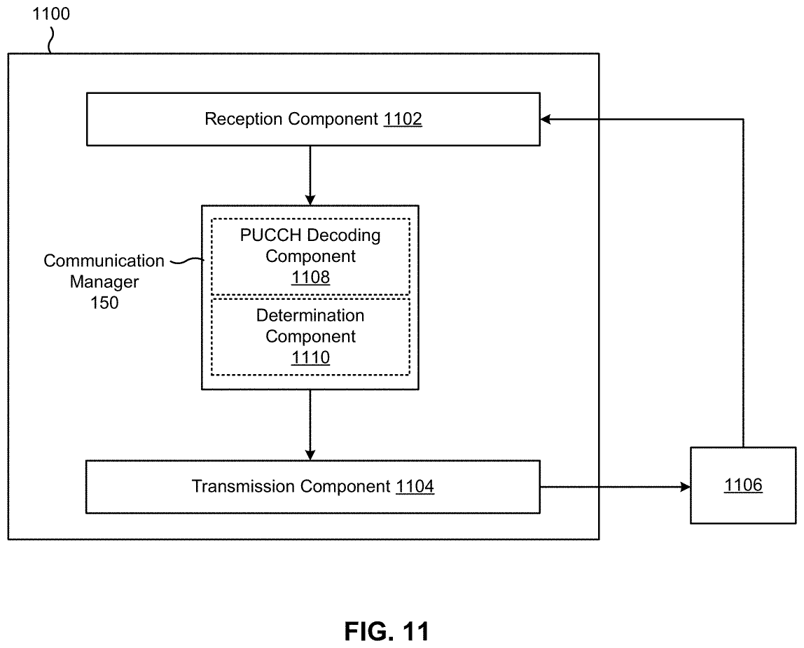

As shown in FIG. 9, in some aspects, process 900 may include receiving, from a UE, a PUCCH communication that includes information, wherein the PUCCH communication is associated with multiple RBs (block 910). For example, the base station (e.g., using communication manager 150 and/or reception component 1102, depicted in FIG. 11) may receive, from a UE, a PUCCH communication that includes information, wherein the PUCCH communication is associated with multiple RBs, as described above.

As further shown in FIG. 9, in some aspects, process 900 may include decoding the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M (block 920). For example, the base station (e.g., using communication manager 150 and/or PUCCH decoding component 1108, depicted in FIG. 11) may decode the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M, as described above.

Process 900 may include additional aspects, such as any single aspect or any combination of aspects described below and/or in connection with one or more other processes described elsewhere herein.

In a first aspect, process 900 includes determining a content of the information based at least in part on the cyclic shift applied to the information.

In a second aspect, alone or in combination with the first aspect, process 900 includes receiving, from another UE, another PUCCH communication that is multiplexed with the PUCCH communication.

In a third aspect, alone or in combination with one or more of the first and second aspects, the PUCCH communication is associated with a PUCCH format 0.

In a fourth aspect, alone or in combination with one or more of the first through third aspects, the information is associated with ACK/NACK feedback and a scheduling request.

In a fifth aspect, alone or in combination with one or more of the first through fourth aspects, the ACK/NACK feedback is associated with a size of 2 bits.

In a sixth aspect, alone or in combination with one or more of the first through fifth aspects, the information is associated with an SR, and wherein a first subset of cyclic shifts, from the set of cyclic shifts, is associated with indicating a positive SR, and wherein a second subset of cyclic shifts, from the set of cyclic shifts, is associated with indicating a negative SR.

In a seventh aspect, alone or in combination with one or more of the first through sixth aspects, the first subset of cyclic shifts include cyclic shift values of M, 4M, 7M, and 10M, and wherein the second subset of cyclic shifts include cyclic shift values of 0, 3M, 6M, and 9M.

In an eighth aspect, alone or in combination with one or more of the first through seventh aspects, the information is associated with a first bit associated with NACK feedback, a second bit associated with NACK feedback, and a negative scheduling request, and wherein the cyclic shift is 0.

In a ninth aspect, alone or in combination with one or more of the first through eighth aspects, the information is associated with a first bit associated with NACK feedback, a second bit associated with NACK feedback, and a positive scheduling request, and wherein the cyclic shift is M.

In a tenth aspect, alone or in combination with one or more of the first through ninth aspects, the information is associated with a first bit associated with NACK feedback, a second bit associated with ACK feedback, and a negative scheduling request, and wherein the cyclic shift is 3M.

In an eleventh aspect, alone or in combination with one or more of the first through tenth aspects, the information is associated with a first bit associated with NACK feedback, a second bit associated with ACK feedback, and a positive scheduling request, and wherein the cyclic shift is 4M.

In a twelfth aspect, alone or in combination with one or more of the first through eleventh aspects, the information is associated with a first bit associated with ACK feedback, a second bit associated with ACK feedback, and a negative scheduling request, and wherein the cyclic shift is 6M.

In a thirteenth aspect, alone or in combination with one or more of the first through twelfth aspects, the information is associated with a first bit associated with ACK feedback, a second bit associated with ACK feedback, and a positive scheduling request, and wherein the cyclic shift is 7M.

In a fourteenth aspect, alone or in combination with one or more of the first through thirteenth aspects, the information is associated with a first bit associated with ACK feedback, a second bit associated with NACK feedback, and a negative scheduling request, and wherein the cyclic shift is 9M.

In a fifteenth aspect, alone or in combination with one or more of the first through fourteenth aspects, the information is associated with a first bit associated with ACK feedback, a second bit associated with NACK feedback, and a negative scheduling request, and wherein the cyclic shift is 10M.

In a sixteenth aspect, alone or in combination with one or more of the first through fifteenth aspects, the set of cyclic shifts is a first set of cyclic shifts, and process 900 includes transmitting, to the UE, an indication to use the first set of cyclic shifts, from the first set of cyclic shifts and a second set of cyclic shifts, for multiple RB PUCCH communications that are associated with a PUCCH format 0.

In a seventeenth aspect, alone or in combination with one or more of the first through sixteenth aspects, the indication to use the first set of cyclic shifts is transmitted via RRC signaling.

In an eighteenth aspect, alone or in combination with one or more of the first through seventeenth aspects, the set of cyclic shifts is a first set of cyclic shifts, and process 900 includes transmitting, to the UE, an indication of the first set of cyclic shifts and a second set of cyclic shifts, wherein the first set of cyclic shifts and the second set of cyclic shifts are associated with multiple RB PUCCH communications that are associated with a PUCCH format 0.

In a nineteenth aspect, alone or in combination with one or more of the first through eighteenth aspects, the set of cyclic shifts is a first set of cyclic shifts, and wherein a second set of cyclic shifts include cyclic shift values of 0, [3M/2], 3M, [9M/2], 6M, [15M/2], 9M, and [21M/2], and wherein the first set of cyclic shifts and the second set of cyclic shifts are associated with multiple RB PUCCH communications that are associated with a PUCCH format 0.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include an information processing component 1008, among other examples.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The information processing component 1008 may process, for a PUCCH communication, information to be included in the PUCCH communication based at least in part on applying a cyclic shift, from a set of cyclic shifts, to the information, wherein the PUCCH communication is associated with multiple RBs, wherein a quantity of the multiple RBs is M, and wherein the set of cyclic shifts include cyclic shift values of 0, M, 3M, 4M, 6M, 7M, 9M, and 10M. The transmission component 1004 may transmit, based at least in part on processing the information, the PUCCH communication including the information.

The information processing component 1008 may select the cyclic shift, from the set of cyclic shifts, based at least in part on a content of the information.

The reception component 1002 may receive, from a base station, an indication to use the first set of cyclic shifts, from the first set of cyclic shifts and a second set of cyclic shifts, for multiple RB PUCCH communications that are associated with a PUCCH format 0.

The reception component 1002 may receive, from a base station, an indication of the first set of cyclic shifts and a second set of cyclic shifts, wherein the first set of cyclic shifts and the second set of cyclic shifts are associated with multiple RB PUCCH communications that are associated with a PUCCH format 0.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include one or more of a PUCCH decoding component 1108, and/or a determination component 1110, among other examples.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The reception component 1102 may receive, from a user equipment, a PUCCH communication that includes information, wherein the PUCCH communication is associated with multiple RBs. The PUCCH decoding component 1108 may decode the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M.

The determination component 1110 may determine a content of the information based at least in part on the cyclic shift applied to the information.

The reception component 1102 may receive, from another UE, another PUCCH communication that is multiplexed with the PUCCH communication.

The transmission component 1104 may transmit, to the UE, an indication to use the first set of cyclic shifts, from the first set of cyclic shifts and a second set of cyclic shifts, for multiple RB PUCCH communications that are associated with a PUCCH format 0.

The transmission component 1104 may transmit, to the UE, an indication of the first set of cyclic shifts and a second set of cyclic shifts, wherein the first set of cyclic shifts and the second set of cyclic shifts are associated with multiple RB PUCCH communications that are associated with a PUCCH format 0.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the base station 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

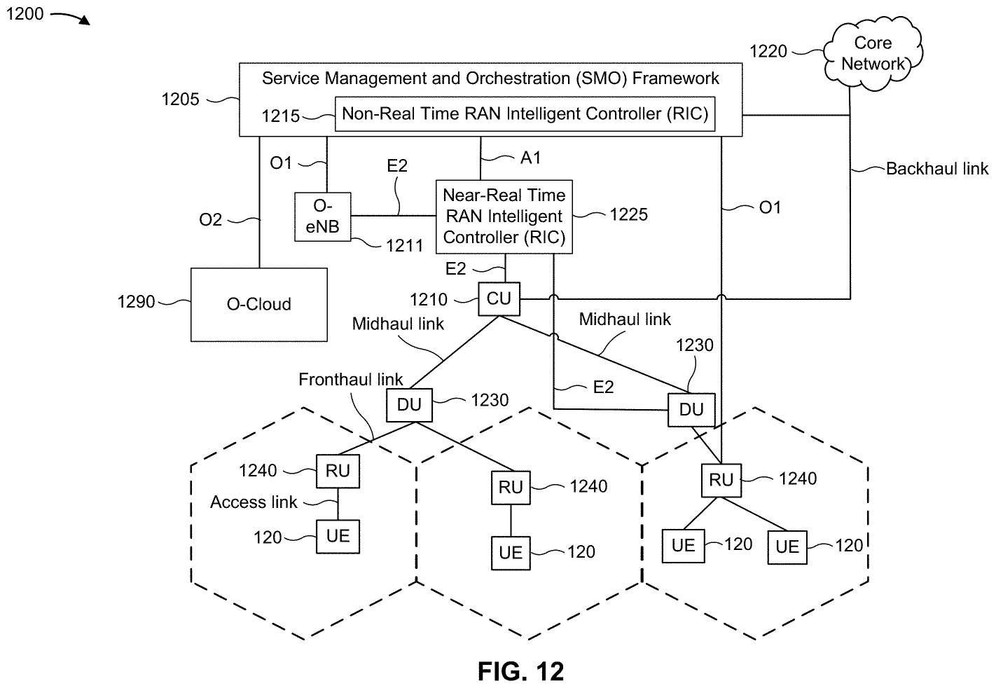

FIG. 12 is a diagram illustrating an example disaggregated base station architecture 1200, in accordance with the present disclosure. The disaggregated base station architecture 1200 may include a CU 1210 that can communicate directly with a core network 1220 via a backhaul link, or indirectly with the core network 1220 through one or more disaggregated control units (such as a Near-RT RIC 1225 via an E2 link, or a Non-RT RIC 1215 associated with a Service Management and Orchestration (SMO) Framework 1205, or both). A CU 1210 may communicate with one or more DUs 1230 via respective midhaul links, such as through F1 interfaces. Each of the DUs 1230 may communicate with one or more RUs 1240 via respective fronthaul links. Each of the RUs 1240 may communicate with one or more UEs 120 via respective radio frequency (RF) access links. In some implementations, a UE 120 may be simultaneously served by multiple RUs 1240.

Each of the units, including the CUs 1210, the DUs 1230, the RUs 1240, as well as the Near-RT RICs 1225, the Non-RT RICs 1215, and the SMO Framework 1205, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 1210 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 1210. The CU 1210 may be configured to handle user plane functionality (for example, Central Unit—User Plane (CU-UP) functionality), control plane functionality (for example, Central Unit—Control Plane (CU-CP) functionality), or a combination thereof. In some implementations, the CU 1210 can be logically split into one or more CU-UP units and one or more CU-CP units. A CU-UP unit can communicate bidirectionally with a CU-CP unit via an interface, such as the E1 interface when implemented in an O-RAN configuration. The CU 1210 can be implemented to communicate with a DU 1230, as necessary, for network control and signaling.

Each DU 1230 may correspond to a logical unit that includes one or more base station functions to control the operation of one or more RUs 1240. In some aspects, the DU 1230 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 1230 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 1230, or with the control functions hosted by the CU 1210.

Each RU 1240 may implement lower-layer functionality. In some deployments, an RU 1240, controlled by a DU 1230, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 1240 can be operated to handle over the air (OTA) communication with one or more UEs 120. In some implementations, real-time and non-real-time aspects of control and user plane communication with the RU(s) 1240 can be controlled by the corresponding DU 1230. In some scenarios, this configuration can enable each DU 1230 and the CU 1210 to be implemented in a cloud-based RAN architecture, such as a vRAN architecture.

The SMO Framework 1205 may be configured to support RAN deployment and provisioning of non-virtualized and virtualized network elements. For non-virtualized network elements, the SMO Framework 1205 may be configured to support the deployment of dedicated physical resources for RAN coverage requirements, which may be managed via an operations and maintenance interface (such as an O1 interface). For virtualized network elements, the SMO Framework 1205 may be configured to interact with a cloud computing platform (such as an open cloud (O-Cloud) platform 1290) to perform network element life cycle management (such as to instantiate virtualized network elements) via a cloud computing platform interface (such as an O2 interface). Such virtualized network elements can include, but are not limited to, CUs 1210, DUs 1230, RUs 1240, non-RT RICs 1215, and Near-RT RICs 1225. In some implementations, the SMO Framework 1205 can communicate with a hardware aspect of a 4G RAN, such as an open eNB (O-eNB) 1211, via an O1 interface. Additionally, in some implementations, the SMO Framework 1205 can communicate directly with each of one or more RUs 1240 via a respective O1 interface. The SMO Framework 1205 also may include a Non-RT RIC 1215 configured to support functionality of the SMO Framework 1205.

The Non-RT RIC 1215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1225. The Non-RT RIC 1215 may be coupled to or communicate with (such as via an A1 interface) the Near-RT RIC 1225. The Near-RT RIC 1225 may be configured to include a logical function that enables near-real-time control and optimization of RAN elements and resources via data collection and actions over an interface (such as via an E2 interface) connecting one or more CUs 1210, one or more DUs 1230, or both, as well as an O-eNB, with the Near-RT MC 1225.

In some implementations, to generate AI/ML models to be deployed in the Near-RT MC 1225, the Non-RT MC 1215 may receive parameters or external enrichment information from external servers. Such information may be utilized by the Near-RT RIC 1225 and may be received at the SMO Framework 1205 or the Non-RT RIC 1215 from non-network data sources or from network functions. In some examples, the Non-RT RIC 1215 or the Near-RT RIC 1225 may be configured to tune RAN behavior or performance. For example, the Non-RT RIC 1215 may monitor long-term trends and patterns for performance and employ AI/ML models to perform corrective actions through the SMO Framework 1205 (such as reconfiguration via an O1 interface) or via creation of RAN management policies (such as A1 interface policies).

As indicated above, FIG. 12 is provided as an example. Other examples may differ from what is described with respect to FIG. 12.

The following provides an overview of some Aspects of the present disclosure:

Aspect 1: A method of wireless communication performed by a user equipment (UE), comprising: processing, for a physical uplink control channel (PUCCH) communication, information to be included in the PUCCH communication based at least in part on applying a cyclic shift, from a set of cyclic shifts, to the information, wherein the PUCCH communication is associated with multiple resource blocks (RBs), wherein a quantity of the multiple RBs is M, and wherein the set of cyclic shifts include cyclic shift values of 0, M, 3M, 4M, 6M, 7M, 9M, and 10M; and transmitting, based at least in part on processing the information, the PUCCH communication including the information.

Aspect 2: The method of Aspect 1, wherein the PUCCH communication is associated with a PUCCH format 0.

Aspect 3: The method of any of Aspects 1-2, further comprising: selecting the cyclic shift, from the set of cyclic shifts, based at least in part on a content of the information.

Aspect 4: The method of any of Aspects 1-3, wherein the information is associated with acknowledgement or negative acknowledgement (ACK/NACK) feedback and a scheduling request.

Aspect 5: The method of Aspect 4, wherein the ACK/NACK feedback is associated with a size of 2 bits.

Aspect 6: The method of any of Aspects 1-5, wherein the information is associated with a scheduling request (SR), and wherein a first subset of cyclic shifts, from the set of cyclic shifts, is associated with indicating a positive SR, and wherein a second subset of cyclic shifts, from the set of cyclic shifts, is associated with indicating a negative SR.

Aspect 7: The method of Aspect 6, wherein the first subset of cyclic shifts include cyclic shift values of M, 4M, 7M, and 10M, and wherein the second subset of cyclic shifts include cyclic shift values of 0, 3M, 6M, and 9M.

Aspect 8: The method of any of Aspects 1-7, wherein the information is associated with a first bit associated with negative acknowledgement (NACK) feedback, a second bit associated with NACK feedback, and a negative scheduling request, and wherein the cyclic shift is 0.

Aspect 9: The method of any of Aspects 1-7, wherein the information is associated with a first bit associated with negative acknowledgement (NACK) feedback, a second bit associated with NACK feedback, and a positive scheduling request, and wherein the cyclic shift is M.

Aspect 10: The method of any of Aspects 1-7, wherein the information is associated with a first bit associated with negative acknowledgement (NACK) feedback, a second bit associated with acknowledgment (ACK) feedback, and a negative scheduling request, and wherein the cyclic shift is 3M.

Aspect 11: The method of any of Aspects 1-7, wherein the information is associated with a first bit associated with negative acknowledgement (NACK) feedback, a second bit associated with acknowledgment (ACK) feedback, and a positive scheduling request, and wherein the cyclic shift is 4M.

Aspect 12: The method of any of Aspects 1-7, wherein the information is associated with a first bit associated with acknowledgement (ACK) feedback, a second bit associated with ACK feedback, and a negative scheduling request, and wherein the cyclic shift is 6M.

Aspect 13: The method of any of Aspects 1-7, wherein the information is associated with a first bit associated with acknowledgement (ACK) feedback, a second bit associated with ACK feedback, and a positive scheduling request, and wherein the cyclic shift is 7M.

Aspect 14: The method of any of Aspects 1-7, wherein the information is associated with a first bit associated with acknowledgement (ACK) feedback, a second bit associated with negative acknowledgement (NACK) feedback, and a negative scheduling request, and wherein the cyclic shift is 9M.

Aspect 15: The method of any of Aspects 1-7, wherein the information is associated with a first bit associated with acknowledgement (ACK) feedback, a second bit associated with negative acknowledgement (NACK) feedback, and a negative scheduling request, and wherein the cyclic shift is 10M.

Aspect 16: The method of any of Aspects 1-15, wherein the set of cyclic shifts is a first set of cyclic shifts, the method further comprising: receiving, from a base station, an indication to use the first set of cyclic shifts, from the first set of cyclic shifts and a second set of cyclic shifts, for multiple RB PUCCH communications that are associated with a PUCCH format 0.

Aspect 17: The method of Aspect 16, wherein the indication to use the first set of cyclic shifts is received via radio resource control (RRC) signaling.

Aspect 18: The method of any of Aspects 1-17, wherein the set of cyclic shifts is a first set of cyclic shifts, the method further comprising: receiving, from a base station, an indication of the first set of cyclic shifts and a second set of cyclic shifts, wherein the first set of cyclic shifts and the second set of cyclic shifts are associated with multiple RB PUCCH communications that are associated with a PUCCH format 0.

Aspect 19: The method of any of Aspects 1-18, wherein the set of cyclic shifts is a first set of cyclic shifts, and wherein a second set of cyclic shifts include cyclic shift values of 0, [3M/2], 3M, [9M/2], 6M, [15M/2], 9M, and [21M/2], and wherein the first set of cyclic shifts and the second set of cyclic shifts are associated with multiple RB PUCCH communications that are associated with a PUCCH format 0.

Aspect 20: A method of wireless communication performed by a base station, comprising: receiving, from a user equipment, a physical uplink control channel (PUCCH) communication that includes information, wherein the PUCCH communication is associated with multiple resource blocks (RBs); and decoding the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M.

Aspect 21: The method of Aspect 20, further comprising: determining a content of the information based at least in part on the cyclic shift applied to the information.

Aspect 22: The method of any of Aspects 20-21, further comprising: receiving, from another UE, another PUCCH communication that is multiplexed with the PUCCH communication.

Aspect 23: The method of any of Aspects 20-22, wherein the PUCCH communication is associated with a PUCCH format 0.

Aspect 24: The method of any of Aspects 20-23, wherein the information is associated with acknowledgement or negative acknowledgement (ACK/NACK) feedback and a scheduling request.

Aspect 25: The method of Aspect 24, wherein the ACK/NACK feedback is associated with a size of 2 bits.

Aspect 26: The method of any of Aspects 20-25, wherein the information is associated with a scheduling request (SR), and wherein a first subset of cyclic shifts, from the set of cyclic shifts, is associated with indicating a positive SR, and wherein a second subset of cyclic shifts, from the set of cyclic shifts, is associated with indicating a negative SR.

Aspect 27: The method of Aspect 26, wherein the first subset of cyclic shifts include cyclic shift values of M, 4M, 7M and 10M, and wherein the second subset of cyclic shifts include cyclic shift values of 0, 3M, 6M, and 9M.

Aspect 28: The method of any of Aspects 20-27, wherein the information is associated with a first bit associated with negative acknowledgement (NACK) feedback, a second bit associated with NACK feedback, and a negative scheduling request, and wherein the cyclic shift is 0.

Aspect 29: The method of any of Aspects 20-27, wherein the information is associated with a first bit associated with negative acknowledgement (NACK) feedback, a second bit associated with NACK feedback, and a positive scheduling request, and wherein the cyclic shift is M.

Aspect 30: The method of any of Aspects 20-27, wherein the information is associated with a first bit associated with negative acknowledgement (NACK) feedback, a second bit associated with acknowledgment (ACK) feedback, and a negative scheduling request, and wherein the cyclic shift is 3M.

Aspect 31: The method of any of Aspects 20-27, wherein the information is associated with a first bit associated with negative acknowledgement (NACK) feedback, a second bit associated with acknowledgment (ACK) feedback, and a positive scheduling request, and wherein the cyclic shift is 4M.

Aspect 32: The method of any of Aspects 20-27, wherein the information is associated with a first bit associated with acknowledgement (ACK) feedback, a second bit associated with ACK feedback, and a negative scheduling request, and wherein the cyclic shift is 6M.

Aspect 33: The method of any of Aspects 20-27, wherein the information is associated with a first bit associated with acknowledgement (ACK) feedback, a second bit associated with ACK feedback, and a positive scheduling request, and wherein the cyclic shift is 7M.

Aspect 34: The method of any of Aspects 20-27, wherein the information is associated with a first bit associated with acknowledgement (ACK) feedback, a second bit associated with negative acknowledgement (NACK) feedback, and a negative scheduling request, and wherein the cyclic shift is 9M.

Aspect 35: The method of any of Aspects 20-27, wherein the information is associated with a first bit associated with acknowledgement (ACK) feedback, a second bit associated with negative acknowledgement (NACK) feedback, and a negative scheduling request, and wherein the cyclic shift is 10M.

Aspect 36: The method of any of Aspects 20-35, wherein the set of cyclic shifts is a first set of cyclic shifts, the method further comprising: transmitting, to the UE, an indication to use the first set of cyclic shifts, from the first set of cyclic shifts and a second set of cyclic shifts, for multiple RB PUCCH communications that are associated with a PUCCH format 0.

Aspect 37: The method of Aspect 36, wherein the indication to use the first set of cyclic shifts is transmitted via radio resource control (RRC) signaling.

Aspect 38: The method of any of Aspects 20-37, wherein the set of cyclic shifts is a first set of cyclic shifts, the method further comprising: transmitting, to the UE, an indication of the first set of cyclic shifts and a second set of cyclic shifts, wherein the first set of cyclic shifts and the second set of cyclic shifts are associated with multiple RB PUCCH communications that are associated with a PUCCH format 0.

Aspect 39: The method of any of Aspects 20-38, wherein the set of cyclic shifts is a first set of cyclic shifts, and wherein a second set of cyclic shifts include cyclic shift values of 0, [3M/2], 3M, [9M/2], 6M, [15M/2], 9M, and [21M/2], and wherein the first set of cyclic shifts and the second set of cyclic shifts are associated with multiple RB PUCCH communications that are associated with a PUCCH format 0.

Aspect 40: An apparatus for wireless communication at a device, comprising a processor; memory coupled with the processor; and instructions stored in the memory and executable by the processor to cause the apparatus to perform the method of one or more of Aspects 1-19.

Aspect 41: A device for wireless communication, comprising a memory and one or more processors coupled to the memory, the one or more processors configured to perform the method of one or more of Aspects 1-19.

Aspect 42: An apparatus for wireless communication, comprising at least one means for performing the method of one or more of Aspects 1-19.

Aspect 43: A non-transitory computer-readable medium storing code for wireless communication, the code comprising instructions executable by a processor to perform the method of one or more of Aspects 1-19.

Aspect 44: A non-transitory computer-readable medium storing a set of instructions for wireless communication, the set of instructions comprising one or more instructions that, when executed by one or more processors of a device, cause the device to perform the method of one or more of Aspects 1-19.

Aspect 45: An apparatus for wireless communication at a device, comprising a processor; memory coupled with the processor; and instructions stored in the memory and executable by the processor to cause the apparatus to perform the method of one or more of Aspects 20-39.

Aspect 46: A device for wireless communication, comprising a memory and one or more processors coupled to the memory, the one or more processors configured to perform the method of one or more of Aspects 20-39.

Aspect 47: An apparatus for wireless communication, comprising at least one means for performing the method of one or more of Aspects 20-39.

Aspect 48: A non-transitory computer-readable medium storing code for wireless communication, the code comprising instructions executable by a processor to perform the method of one or more of Aspects 20-39.

Aspect 49: A non-transitory computer-readable medium storing a set of instructions for wireless communication, the set of instructions comprising one or more instructions that, when executed by one or more processors of a device, cause the device to perform the method of one or more of Aspects 20-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
process, for a physical uplink control channel (PUCCH) communication, information to be included in the PUCCH communication based at least in part on applying a cyclic shift, from a set of cyclic shifts, to the information, wherein the PUCCH communication is associated with multiple resource blocks (RBs), wherein a quantity of the multiple RBs is M, and wherein the set of cyclic shifts include cyclic shift values of 0, M, 3M, 4M, 6M, 7M, 9M, and 10M; and
transmit, based at least in part on processing the information, the PUCCH communication including the information.

2. The UE of claim 1, wherein the PUCCH communication is associated with a PUCCH format 0.

3. The UE of claim 1, wherein the one or more processors are further configured to:
select the cyclic shift, from the set of cyclic shifts, based at least in part on a content of the information.

4. The UE of claim 1, wherein the information is associated with acknowledgement or negative acknowledgement (ACK/NACK) feedback and a scheduling request.

5. The UE of claim 4, wherein the ACK/NACK feedback is associated with a size of 2 bits.

6. The UE of claim 1, wherein the information is associated with a scheduling request (SR), and wherein a first subset of cyclic shifts, from the set of cyclic shifts, is associated with indicating a positive SR, and wherein a second subset of cyclic shifts, from the set of cyclic shifts, is associated with indicating a negative SR.

7. The UE of claim 6, wherein the first subset of cyclic shifts include cyclic shift values of M, 4M, 7M, and 10M, and wherein the second subset of cyclic shifts include cyclic shift values of 0, 3M, 6M, and 9M.

8. The UE of claim 1, wherein the set of cyclic shifts is a first set of cyclic shifts, wherein the one or more processors are further configured to:
receive, from a base station, an indication to use the first set of cyclic shifts, from the first set of cyclic shifts and a second set of cyclic shifts, for multiple RB PUCCH communications that are associated with a PUCCH format 0.

9. The UE of claim 8, wherein the indication to use the first set of cyclic shifts is received via radio resource control (RRC) signaling.

10. The UE of claim 1, wherein the set of cyclic shifts is a first set of cyclic shifts, wherein the one or more processors are further configured to:
receive, from a base station, an indication of the first set of cyclic shifts and a second set of cyclic shifts, wherein the first set of cyclic shifts and the second set of cyclic shifts are associated with multiple RB PUCCH communications that are associated with a PUCCH format 0.

11. The UE of claim 1, wherein the set of cyclic shifts is a first set of cyclic shifts, and wherein a second set of cyclic shifts include cyclic shift values of 0, [3M/2], 3M, [9M/2], 6M, [15M/2], 9M, and [21M/2], and wherein the first set of cyclic shifts and the second set of cyclic shifts are associated with multiple RB PUCCH communications that are associated with a PUCCH format 0.

12. A base station for wireless communication, comprising:
a memory; and
one or more processors, coupled to the memory, configured to:
receive, from a user equipment (UE), a physical uplink control channel (PUCCH) communication that includes information, wherein the PUCCH communication is associated with multiple resource blocks (RBs); and
decode the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M.

13. The base station of claim 12, wherein the one or more processors are further configured to:
determine a content of the information based at least in part on the cyclic shift applied to the information.

14. The base station of claim 12, wherein the one or more processors are further configured to:
receive, from another UE, another PUCCH communication that is multiplexed with the PUCCH communication.

15. The base station of claim 12, wherein the set of cyclic shifts is a first set of cyclic shifts, wherein the one or more processors are further configured to:
transmit, to the UE, an indication to use the first set of cyclic shifts, from the first set of cyclic shifts and a second set of cyclic shifts, for multiple RB PUCCH communications that are associated with a PUCCH format 0.

16. A method of wireless communication performed by a user equipment (UE), comprising:
processing, for a physical uplink control channel (PUCCH) communication, information to be included in the PUCCH communication based at least in part on applying a cyclic shift, from a set of cyclic shifts, to the information, wherein the PUCCH communication is associated with multiple resource blocks (RBs), wherein a quantity of the multiple RBs is M, and wherein the set of cyclic shifts include cyclic shift values of 0, M, 3M, 4M, 6M, 7M, 9M, and 10M; and
transmitting, based at least in part on processing the information, the PUCCH communication including the information.

17. The method of claim 16, wherein the PUCCH communication is associated with a PUCCH format 0.

18. The method of claim 16, further comprising:
selecting the cyclic shift, from the set of cyclic shifts, based at least in part on a content of the information.

19. The method of claim 16, wherein the information is associated with acknowledgement or negative acknowledgement (ACK/NACK) feedback and a scheduling request.

20. The method of claim 19, wherein the ACK/NACK feedback is associated with a size of 2 bits.

21. The method of claim 16, wherein the information is associated with a scheduling request (SR), and wherein a first subset of cyclic shifts, from the set of cyclic shifts, is associated with indicating a positive SR, and wherein a second subset of cyclic shifts, from the set of cyclic shifts, is associated with indicating a negative SR.

22. The method of claim 21, wherein the first subset of cyclic shifts include cyclic shift values of M, 4M, 7M, and 10M, and wherein the second subset of cyclic shifts include cyclic shift values of 0, 3M, 6M, and 9M.

23. The method of claim 16, wherein the set of cyclic shifts is a first set of cyclic shifts, the method further comprising:
receiving, from a base station, an indication to use the first set of cyclic shifts, from the first set of cyclic shifts and a second set of cyclic shifts, for multiple RB PUCCH communications that are associated with a PUCCH format 0.

24. The method of claim 23, wherein the indication to use the first set of cyclic shifts is received via radio resource control (RRC) signaling.

25. The method of claim 16, wherein the set of cyclic shifts is a first set of cyclic shifts, the method further comprising:
receiving, from a base station, an indication of the first set of cyclic shifts and a second set of cyclic shifts, wherein the first set of cyclic shifts and the second set of cyclic shifts are associated with multiple RB PUCCH communications that are associated with a PUCCH format 0.

26. The method of claim 16, wherein the set of cyclic shifts is a first set of cyclic shifts, and wherein a second set of cyclic shifts include cyclic shift values of 0, └3M/2┘, 3M, └9M/2┘, 6M, └15M/2┘, 9M, and └21M/2┘, and wherein the first set of cyclic shifts and the second set of cyclic shifts are associated with multiple RB PUCCH communications that are associated with a PUCCH format 0.

27. A method of wireless communication performed by a base station, comprising:
receiving, from a user equipment (UE), a physical uplink control channel (PUCCH) communication that includes information, wherein the PUCCH communication is associated with multiple resource blocks (RBs); and
decoding the PUCCH communication to obtain the information based at least in part on a cyclic shift applied to the information, wherein the cyclic shift is associated with a set of cyclic shifts, wherein a quantity of the multiple RBs is M, and wherein the set of cyclic shifts include cyclic shift values of 0, M, 3M, 4M, 6M, 7M, 9M, and 10M.

28. The method of claim 27, wherein the set of cyclic shifts is a first set of cyclic shifts, the method further comprising:
transmitting, to the UE, an indication to use the first set of cyclic shifts, from the first set of cyclic shifts and a second set of cyclic shifts, for multiple RB PUCCH communications that are associated with a PUCCH format 0.

29. The method of claim 27, wherein the set of cyclic shifts is a first set of cyclic shifts, the method further comprising:
transmitting, to the UE, an indication of the first set of cyclic shifts and a second set of cyclic shifts, wherein the first set of cyclic shifts and the second set of cyclic shifts are associated with multiple RB PUCCH communications that are associated with a PUCCH format 0.

30. The method of claim 27, wherein the set of cyclic shifts is a first set of cyclic shifts, and wherein a second set of cyclic shifts include cyclic shift values of 0, └3M/2┘, 3M, └9M/2┘, 6M, └15M/2┘, 9M, and └21M/2┘, and wherein the first set of cyclic shifts and the second set of cyclic shifts are associated with multiple RB PUCCH communications that are associated with a PUCCH format 0.
